(19) United States
(12) Patent Application Publication
(10) Pub. No.: US 2004/0064531 A1
(43) Pub. Date: Apr. 1, 2004

(54) System and process for projecting hardware requirements for a web site

(76) Inventor: Steven P. Wisner, Richmond, VA (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(21) Appl. No.: 10/260,607

(22) Filed: Oct. 1, 2002

(51) Int. Cl. G06F 15/177

(52) U.S. Cl. 709/221

(57) ABSTRACT

A process and system are provided for projecting hardware requirements for a web site. The process and system employ a performance model and a user model that together enable prediction of a number of concurrent users that the web site can support. The two models also enable determination of a hardware configuration that would be required to support the predicted number of concurrent users. The two models are used together to achieve scalability of the web site.

### FIELD OF THE INVENTION

The present invention relates to a system and process for projecting hardware requirements of a web site in order to achieve “scalability” of the web site (i.e., the ability to grow or shrink such web site and applications as desired) and its associated applications. In particular, the invention relates to a system and process for ensuring that the hardware and software provided for a web site can support a desired number of concurrent users with acceptable response times and functionality.

### BACKGROUND OF THE INVENTION

In recent years, the growth of e-commerce has caused web site proprietors to have frequent occasion to reevaluate their hardware and software needs for their web sites. Frequently, a web site proprietor faces the realization that an initial amount of software and hardware allocated to a web site is insufficient to accommodate a number of concurrent users accessing the web site (i.e., the “load” on the web site). Additionally, response times for accessing the web site, performing certain activities within the web site, and retrieving desired information from the web site may become so slow that a user of the web site exits the web site due to the slow response time.

For example, some web site proprietors, such as Internet “start-up companies,” can only guess at the loads their web sites will be required to handle. Such web sites may initially be developed on a small scale, and the web site proprietors may have an intention of expanding the web sites in the future. However, if a web site is selling products or services which are in great demand or the web site offers incentives to users who access the web site in order to increase the number of users of the web site, or the web site is actively engaged in advertising and publicizing the products or services sold via the web site, such a web site often ends up becoming quickly overburdened by a large number of concurrent users. The proprietor of the web site may not be able to respond quickly enough by adding hardware, software and features to the web site to address the large number of concurrent users. Consequently, the web site may experience technical difficulties such as “crashes” or slow response times because it was not designed to handle the traffic level loads. Many times such technical difficulties result in a loss in consumer goodwill which can be irretrievable. And, the web site proprietor may lose potential customers while trying to redesign the web site to meet the large volume of concurrent users. Additionally, the cost of purchasing and integrating the additional hardware and/or software required to support the large volume of users can often be great.

Some web sites have reported experiencing growth of over 1,000 percent in a period of less than one month following launch of the web site or in response to an advertising campaign. Such growth numbers highlight the importance of planning for a rapid natural growth and significant jumps in traffic associated with such publicity and advertising.

Before attempting to accommodate a growing number of concurrent users of a web site, a web site proprietor must determine which specific technical feature is a source of a bottleneck creating delays in response times and/or crashes of the web site. The bottleneck could be either hardware or software related. Additionally, the web site proprietor needs to monitor and understand the nature of the web site usage in order to achieve scalability. For instance, it is useful to monitor the number of web site users, the time spent by each user within the web site, the specific pages of a web site which are frequently visited, and the tasks performed by each user while accessing the web site in order to determine a source of the bottleneck.

A system and/or process is needed to avoid web site technical difficulties, such as web site crashes and slow response times, among other difficulties, by projecting in advance a predicted number of concurrent users for a web site. Furthermore, a system and/or process is needed to accurately determine an amount of hardware required to support the predicted number of concurrent users of the web site. Moreover, such predictions should be accurate for at least a minimum amount of time into the future to lessen a number of future redesigns or hardware upgrades required for the web site. Additionally, there is a need for a process whereby such user number and hardware predictions can be tested prior to implementation of any web site redesign or hardware upgrade to the web site.

### SUMMARY OF THE INVENTION

It is accordingly an aspect of the invention to provide a system and process for projecting hardware requirements for a web site.

It may further be desirable to provide a system and process for predicting a number of concurrent users that can access and use a web site at a single time.

Another object of the invention is to provide a process for building a performance model for testing a web site prior to implementation of a design change or a hardware upgrade to the web site.

According to an exemplary embodiment of the invention, a process for projecting hardware requirements for a web site, wherein the web site makes use of a particular application platform, provides the steps of building a performance model for the web site, wherein the step of building the performance model includes the sub-steps of: a) selecting at least one feature for the web site; b) selecting at least one web application task to execute from among a plurality of web application tasks which can be executed by a user of the web site via a browser; and c) selecting a number of browsers to access the web site concurrently, each of the number of browsers corresponding to a user of the web site; formulating a user model by predicting a plurality of parameters, the plurality of parameters including a number of concurrent users, an average latency time, and a desired response time, calculating a desired capacity figure based on the predicted plurality of parameters, and predicting a required hardware configuration.

By way of another exemplary embodiment of the invention, a process for predicting a maximum number of concurrent users that can be supported by a web site using a particular hardware configuration, provides building a performance model for the web site and the particular hardware configuration, wherein building the performance model includes the sub-steps of: selecting at least one web application task from among a plurality of application tasks which can be executed by a user of the web site via a browser; and selecting a number of browsers to access the web site concurrently; calculating a capacity figure. The embodiment further provides formulating a user model by predicting an average latency time and a desired response time, and calculating the maximum number of concurrent users that can be supported by the web site by selecting the calculated capacity figure from an appropriate result category and multiplying the selected calculated capacity figure by the sum of the average latency time and the desired response time.

According to an additional embodiment of the invention, a process for building a performance model for a web site, provides the steps of selecting a plurality of features for the performance model including a particular programming language platform, selecting at least one web application task from among a plurality of web application tasks which can be executed by a user of the web site, selecting at least one CPU configuration from among a plurality of CPU configurations, selecting a number of browsers to access the web site concurrently, creating a plurality of result categories by forming a graph having a first axis corresponding to the selected web application task and a second axis corresponding to the selected CPU configuration; performing a capacity test for each one of the plurality of result categories using the selected web application task, and calculating a capacity figure for each one of the plurality of result categories, wherein the step of calculating the capacity figure includes the sub-steps of determining an average response time, and dividing the selected number of browsers accessing the web site by the determined average response time.

A further exemplary embodiment of the invention provides a system for predicting hardware requirements for a web site, wherein the web site uses a particular programming language platform, where the system includes a performance model for the web site, wherein the performance model includes a plurality of capacity result categories, a capacity figure being provided for each one of the plurality of capacity result categories, each of the capacity figures being determined as a quotient of a number of browsers accessing the web site concurrently divided by an average response time for the number of browsers to execute a selected web application task, a user model including means for predicting a plurality of parameters including a number of concurrent users, an average latency time, and a desired response time, and means for calculating a desired capacity figure based on the predicted plurality of parameters, and comparison means for predicting a required hardware configuration by comparing the calculated desired capacity figure with the determined capacity figures of the performance model.

A system for predicting a number of concurrent users that can be supported by a web site using a particular hardware configuration provides, in another embodiment of the present invention, a performance model for the web site and the particular hardware configuration, wherein the web site includes a plurality of web application tasks which can be executed by a user of the web site, a result category for each one of the plurality of web application tasks and a capacity figure for each result category, wherein each one of the capacity figures is determined by a number of browsers accessing the web site concurrently divided by an average response time, and a user model including a plurality of user parameters including an average latency time and a desired response time, the user model including means for calculating the maximum number of concurrent users than can be supported by the web site by selecting the capacity figure from an appropriate result category and multiplying the selected capacity figure by the sum of the average latency time and the desired response time.

By way of an additional exemplary embodiment of the invention, a medium storing code for causing a processor to project hardware requirements for a web site, wherein the web site makes use of a particular application platform, where the medium provides code for building a performance model for the web site, wherein the code for building the performance model includes: a) code for selecting at least one feature for the web site; b) code for selecting at least one web application task to execute from among a plurality of web application tasks which can be executed by a user of the web site via a browser; and c) code for selecting a number of browsers to access the web site concurrently, each of the number of browsers corresponding to a user of the web site. The medium further provides code for formulating a user model by predicting a plurality of parameters, the plurality of parameters including a number of concurrent users, an average latency time, and a desired response time, code for calculating a desired capacity figure based on the predicted plurality of parameters, and code for predicting a required hardware configuration.

In another example of an embodiment of the invention, a medium storing code for causing a processor to build a performance model for a web site provides code for selecting a plurality of features for the performance model including a particular programming language platform, code for selecting at least one web application task from among a plurality of web application tasks which can be executed by a user of the web site, code for selecting at least one CPU configuration from among a plurality of CPU configurations, code for selecting a number of browsers to access the web site concurrently, code for creating a plurality of result categories by forming a graph having a first axis corresponding to the selected web application task and a second axis corresponding to the selected CPU configuration, code for performing a capacity test for each one of the plurality of result categories using the selected web application task, and code for calculating a capacity figure for each one of the plurality of result categories, wherein the step of calculating the capacity figure includes the sub-steps of determining an average response time, and dividing the selected number of browsers accessing the web site by the determined average response time.

These and other features, aspects and advantages of the embodiments of the invention will become apparent when the detailed description is read in conjunction with the drawings attached hereto.

### BRIEF DESCRIPTION OF THE DRAWINGS

FIG. 1 is a block diagram illustrating an embodiment of a system for predicting hardware requirements for a web site in accordance with the present invention;

FIG. 2 is a block diagram illustrating an embodiment of a performance model in accordance with the present invention;

FIG. 3A is a table illustrating exemplary result categories of the performance model;

FIG. 3B is a table illustrating an exemplary mix of web application tasks for execution by a user of a web site;

FIG. 3C is an example of a performance scale factor for the mix of web application tasks in the table of FIG. 4A;

FIG. 4 is a block diagram illustrating an embodiment of a user model in accordance with the present invention;

FIG. 5 illustrates the steps in the process of predicting hardware requirements of a web site;

FIG. 6 is a flow chart illustrating the steps in the process for building the performance model of the invention;

FIG. 7 is a flow chart illustrating the steps in the process of building a user model in accordance with another embodiment of the invention;

FIG. 8 is a flow chart illustrating the steps in the process of determining a number of concurrent users that can be supported by the web site;

FIG. 9 is a flow chart illustrating the steps in the process of building a user model in accordance with an embodiment of the invention;

FIG. 10 is a flow chart illustrating the steps of predicting hardware requirements; and

FIGS. 11 and 12 are representations on information presented for a user model according to an embodiment of the invention.

### DETAILED DESCRIPTION OF THE PREFERRED EMBODIMENTS

Reference will now be made in detail to the present preferred embodiments of the invention, examples of which are illustrated in the accompanying drawings in which like reference numerals refer to corresponding elements.

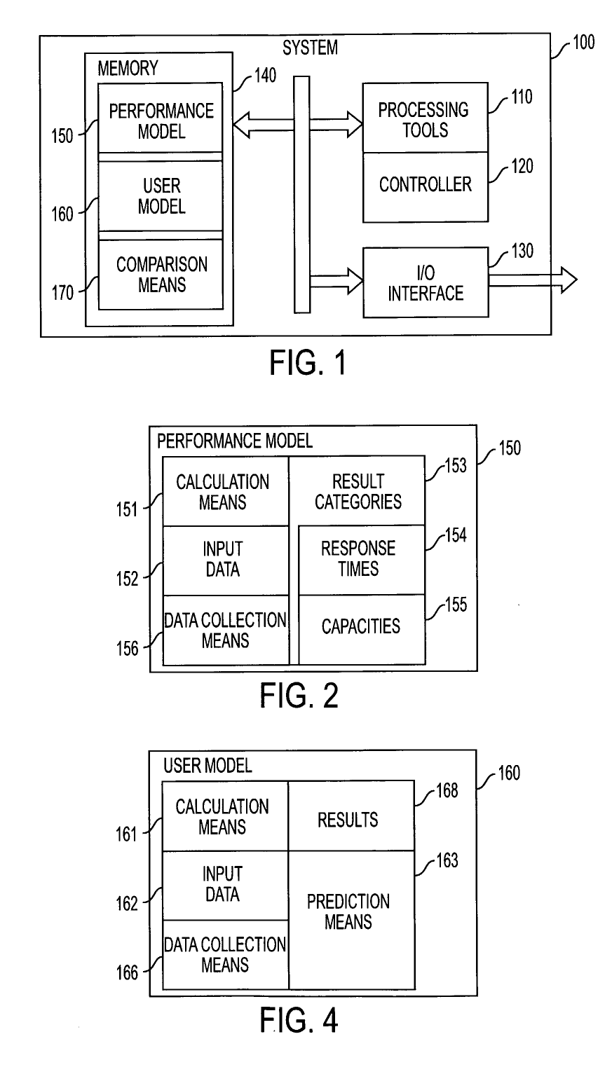

FIG. 1 is a block diagram illustrating an embodiment of a system 100 for predicting hardware requirements for a web site. The system 100 comprises a plurality of processing tools 110, a controller 120, an I/O interface 130, and a memory 140. Stored within the memory 140 are a performance model 150, a user model 160, and a comparison means 170. The performance model 150 is constructed to provide a plurality of capacity figures for a plurality of selected web application tasks which can be executed by a user of the web site in combination with one of plurality of selected preliminary hardware configurations as will be further explained below. A separate performance model may be constructed for each one of the plurality of preliminary hardware configurations and for each different web application task and application platform of the web site. A “web application task” may be defined as a web-based application written in a particular programming language that can be executed by users of the web site (each using a browser to access the web site and to execute the task) via hypertext transfer protocol (HTTP). An application platform corresponds to the programming language used for an application server for the web site for example, Netscape version 4.0 or Broadvision. As discussed below, the user model 160 incorporates four different variables which should be reviewed when designing a web site to determine the scalability of a proposed configuration of the web site. If any three of the four different variables are known or are satisfactorily predicted, the user model 160 can calculate a remaining one of the four different variables as will be further explained below.

FIG. 2 illustrates a plurality of components of the performance model 150. As shown, the performance model 150 comprises a data collection means 156, a plurality of input data 152, a calculation means 151, and a plurality of result categories 153. The result categories 153 include a plurality of response times 154 and a plurality of capacities 155. In operation, the data collection means 156 tests a web site in conjunction with a selected preliminary hardware configuration and a selected number of free-running browsers concurrently accessing the web site. (Each of the free-running browsers accessing the web site may correspond to a unique user of the web site.) To create an adequate number of result categories 153, the data collection means 156 must test each one of the plurality of preliminary hardware configurations. For example, the plurality of preliminary hardware configurations may include a 2N CPU configuration, where N is a natural number (e.g., a 1 CPU configuration, a 2 CPU configuration, a 4 CPU configuration, an 8 CPU configuration, etc.). By way of another exemplary embodiment, the plurality of preliminary hardware may include a 1 CPU configuration and a 2(N) CPU configuration, where N is greater than zero e.g., a 1 CPU configuration, a 2 CPU configuration, a 4 CPU configuration, a 6 CPU configuration, etc. Other configuration algorithms may also be used.

The web site can be tested by executing one or more web application tasks in connection with each one of the plurality of preliminary hardware configurations. Possible web application tasks which can be executed by such browser access include, but are not limited to, a query, a page request, a transaction, or a combination of all of these web application tasks. A response time for executing a selected one of the web application tasks after a browser access of the web site can be observed. A plurality of such response times are observed for the one of the web application tasks for a selected number of browsers accessing the web site concurrently. Then, an average response time for executing the selected one of the web applications tasks can be calculated by adding the plurality of observed response times for each of the selected number of browsers accessing the web site concurrently and dividing a sum of the plurality of observed response times by the selected number of browsers accessing the web site concurrently. This enables a determination to be made of a load (i.e., a number of concurrent users) which can be supported by a particular one of the preliminary hardware configurations.

All of the aforementioned data can be used as input data 152 for processing by the calculation means 151. The calculation means 151 can calculate a capacity figure result for each executed web application task and each of the plurality of preliminary hardware configurations.

The capacity figure result is equal to a function of the selected number of browsers accessing the web site, the performance of the internal subsystems that generate latency and the average response time for execution of the selected one of the web application tasks in combination with one of the preliminary hardware configurations.

Capacity Figure Result=f(number of browsers accessing web site, performance of internal subsystems that generate latency, average response time). (1)

The capacity figure result can be calculated in this manner because an average number of executed web application tasks in a specified unit of time will be a constant value independent of the selected number of browsers as long as the selected number of browsers accessing the web site concurrently meets a predetermined minimum number of browsers appropriate to the web site. Accordingly, the number of browsers accessing the web site concurrently should not be selected below this predetermined minimum number of browsers.

As an example, assume the selected number of browsers concurrently accessing a server for the web site is set to 10, and that each of the browsers requests to execute a fixed mix of web application tasks in connection with the web site. Assume further that an average response time per executed web application task is observed as 2 seconds. Using equation (1) above, the capacity figure will equal 5 executed web application tasks (or “transactions”) per second or three hundred transactions per minute. Since the capacity figure is expected to remain constant for the web site, if twenty free-running browsers were used to concurrently access the web site to execute a specified web application task, we would expect to observe an average response time of four seconds.

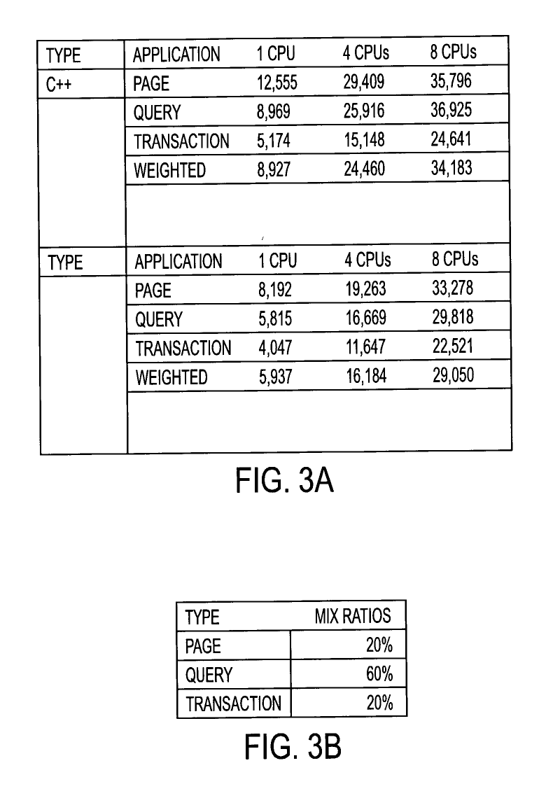

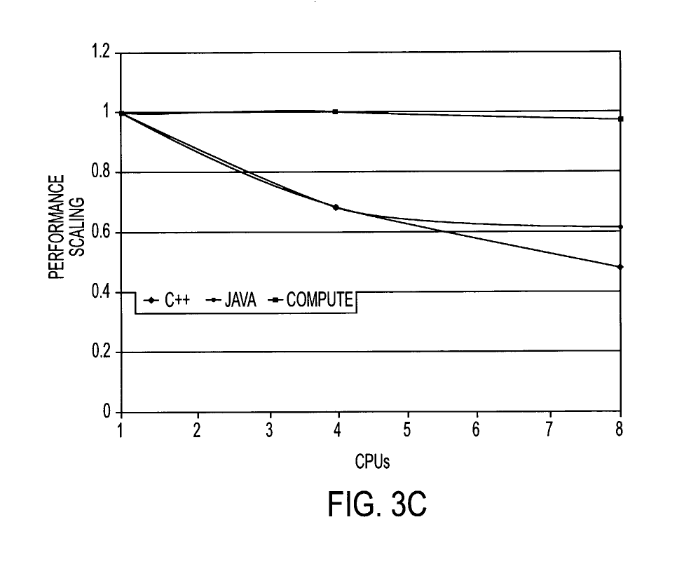

Each of the Tables in FIG. 3A displays a capacity figure for each of the three different CPU configurations set forth above. Assuming the web site supports two different programming language platforms, i.e., the results shown in Table 1 are for the C++ programming language platform and the results shown in Table 2 are for the Java programming language platform. Tests were performed for each possible web application task including page requests, transaction requests, queries, and a weighted combination of these web application tasks. (A mix ratio for such weighted combinations of web application tasks is shown in FIG. 3B). The capacity figures for each one of the CPU configurations and for each one of the web application tasks are expressed in terms of a number of transactions per minute. The capacity figures observed show that, generally speaking, page requests are executed most quickly (i.e., a higher number of page requests per minute can be performed for any of the three CPU configurations), followed by queries and transaction requests. Since the weighted combination of web application tasks is 60 percent comprised of queries, in the performance model shown, the capacity results for the weighted combinations are very similar to the capacity results for queries.

Each of the numerical values for capacity results listed in FIG. 3A correspond to one of the plurality of sample performance model result categories 153. The sample performance model result categories 153 are used to store a result 154 for each web application task executed in combination with each hardware configuration. The data shown in FIGS. 3A and 3B were obtained using a plurality of SPARC™ based application servers and a Solaris operating environment over Intel/NT systems. The testing should be performed with a web server tier and an application server tier that are similar in capacity in order to avoid a slow down in the web server response time resulting in bottlenecks. When a host CPU for the web server is less powerful than a host CPU for the application sever, a bottleneck at the web server can occur.

With regard to an amount of memory space required for testing, optimal performance may be achieved if the performance model on which the testing is performed has minimum amount of memory necessary to perform the functions. According to an embodiment of the invention, at least 1 GB of memory may be required. However, other amounts may also be used. The provision of this quantity of memory guards against bottlenecks.

FIG. 3C is an illustrative graph of a performance scale for the weighted combination of the three web application tasks plotted against each of the number of CPUs. The results for a web site built on a C++ programming language platform are plotted on this chart to depict an ideal number of CPUs for the web site to achieve a performance scale factor of 1.0 without consideration of I/O hardware requirements. (A performance scale factor of 1.0 means that the selected hardware configuration is appropriately scaled for the number of concurrent users for the web site.) The graph shows that near perfect scalability (i.e., a performance scale factor of 1.0) is achievable when the only hardware resource used is a single CPU. The nonlinear relationship between performance scaling and number of CPUs as shown in FIG. 3C is characteristic of software applications that rely on additional system resources (other than the CPU) for execution. Unless the capacities of the other utilized system resources are proportionally increased, increasing the processing capacity (by adding CPUs) can only scale up the performance until one or more of the other system resources becomes constrained. According to an embodiment of the invention, initial information may be provided by vendors of various systems, subsystems and features incorporated into the web site. A vendor may provide initial data and information, and the information may later be refined based on subsequent testing.

In most web application tasks that involve frequent queries and retrievals of data stored in a database, the I/O interface 30 eventually becomes the resource that causes bottlenecks on the web site. The performance scaling numbers for the database itself, therefore, set the performance “upper bound” for any web application tasks that frequently access data from the database. Any discrepancies between the performance scaling numbers for the database and the performance scaling numbers for the web site can be attributed to either the design of the web site itself, or the programming language platform on which the web site is running.

FIG. 4 illustrates the components of user model 160. User model 160 comprises a calculation module 161, a plurality of input data 162, a prediction module 163, a data collection module 166 and a plurality of results 168. The user model 160 is fully formed when four variables including a capacity figure, an average response time, a latency time, and a number of concurrent users are ascertained. The equation that forms the basis of the user model 160 is as follows:

Number of concurrent users=f(Capacity figure, average response time, latency time). (2)

The user model 160 can be used in at least two ways. First, if the capacity figure, the average response time, and the latency time have previously been determined in the process of building the performance model 150, then the user model 160 can be used to predict the number of concurrent users that can be supported by the web site. Alternatively, a web site proprietor may know, prior to launching the web site, a projected ideal number of concurrent users for which to design the web site as well as an ideal total response time. In such a case, equation (2) can be used to calculate the missing variable, i.e., the required capacity figure. Comparison module 170 can then compare the calculated required capacity figure derived from the user model 160 with each of the capacity figures of each of the result categories of the performance model 150 for a match. The preliminary hardware configuration of the matching capacity figure of the capacity result category of the performance model 150 will be the required hardware configuration needed to support the projected ideal number of concurrent users.

In operation, data collection module 166 collects data either from the performance model 150 or from the prediction module 163. Performance model 160 can provide the response times and the capacity figures. Prediction module 163 can provide the number of concurrent users and the desired response times. In either case, the collected data collected by data collection module 166 can be stored as the input data 162.

If the input data 162 is collected from the prediction module 163, the number of concurrent users is preferably determined based on a predicted natural growth figure of concurrent users and a predicted growth figure of concurrent users resulting from advertising or publicity. The response time can be based on the web site proprietor's estimates of a projected ideal response time required for users to maintain interest in the web site and to execute a particular web application task.

The collected input data 162 is forwarded to the calculation module 161, which operates to solve an undetermined variable needed for equation (2).

The comparison module 170 can be used to compare results obtained from the user model 160 and the performance model 150 to reach appropriate conclusions, such as the required hardware configuration needed for the web site.

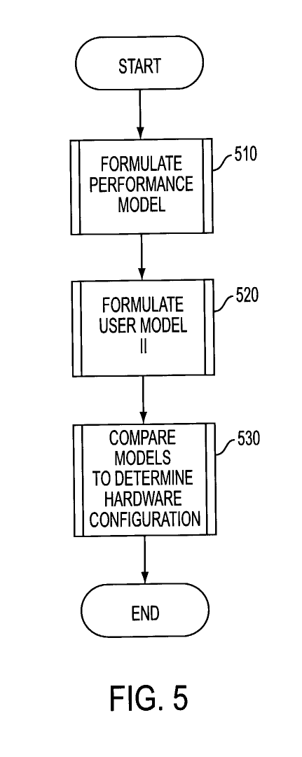

FIG. 5 illustrates the steps involved in the process for determining the required hardware configuration for a web site. A performance model 150 is constructed in step 510. A user model 160 is constructed in step 520. In step 530, the results of the testing using the user model 160 are compared to the results of the testing using the performance model 150 to determine the hardware configuration best suited for the web site to support a projected number of concurrent users of the web site.

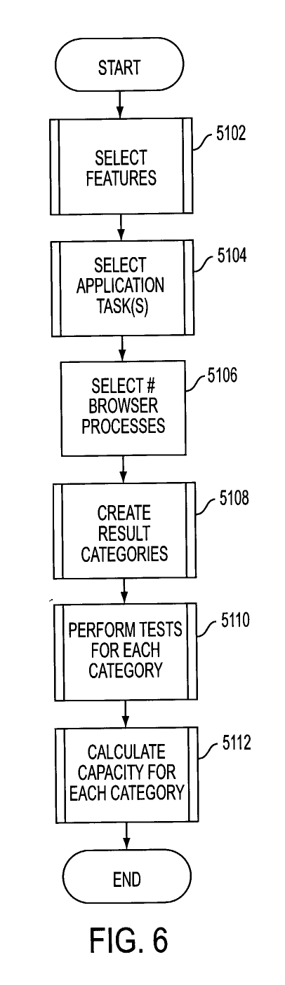

FIG. 6 depicts the sub-steps involved in the process of building the performance model 150 in accordance with step 510 of FIG. 5. In step 5102, a plurality of features are selected for the web site including a programming language platform, and a preliminary hardware configuration. In sub-step 5104, one of a plurality of web application tasks or a weighted combination of the plurality of web application tasks is selected. In sub-step 5106, a number of browsers concurrently to access the web site is selected. As explained above, the selection of an arbitrarily low number of browsers can skew the results. Accordingly, it may be desirable to select five or more browsers. In sub-step 5108, a plurality of result categories 153 are developed. In the embodiments shown, the plurality of result categories 153 are developed by constructing a graph having one axis for the selected preliminary hardware configuration and another axis for the selected web application task. Separate performance models may be necessary for each programming language platform for the web site. For instance, separate performance models may be needed for a web site using each one of a Java platform, a C++ platform, Netscape platform and/or a Broadvision platform. In sub-step 5110, a plurality of tests are performed for each result category 153. A test is performed by allowing the selected number of browsers concurrently to access the web site and execute the selected web application task. Each of the performed tests yields a plurality of average response times, one average response time for each of the selected web application tasks. According to an embodiment of the invention, testing may be one of actual testing or virtual testing. Actual testing may comprise creating the propose web site in a particular hardware configuration and enabling users to access and test it. Virtual testing may comprise creating a mock web site and enabling simulations to be performed. Finally in sub-step 5112, a capacity figure is calculated for each of the result categories 153. The capacity figure calculation is performed by dividing the selected number of browsers by the average response times for execution of each of the web application tasks.

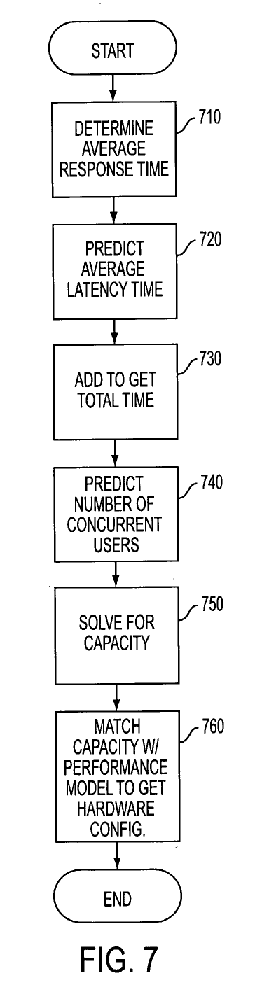

FIG. 7 illustrates the steps used in the process for building the user model 160 in order to facilitate selection of a hardware configuration. In sub-step 710, an average response time is determined. In sub-step 720, an average latency time is predicted. The average latency time is equal to the time a user of the web site spends viewing the web site or receives data across the network, but not executing any web application tasks. In sub-step 730, the predicted average latency time and the determined average response time are added to determine a total response time figure. In sub-step 740, a number of predicted concurrent users of the web site is determined. The user model 160 can then be used to determine a capacity figure in sub-step 750. The determined capacity figure is equal to the predicted number of concurrent users divided by the total response time figure. In sub-step 760, comparison means 170 compares the determined capacity figure using the user model 160 with the capacity figure determined through use of the performance model 150 and calculates a difference of the determined capacity figure using the user model 160 and the capacity figure determined through the performance model 150. A result category 153 for the difference calculated by the comparison means 170 will correspond to the capacity of the appropriate hardware configuration for the web site.

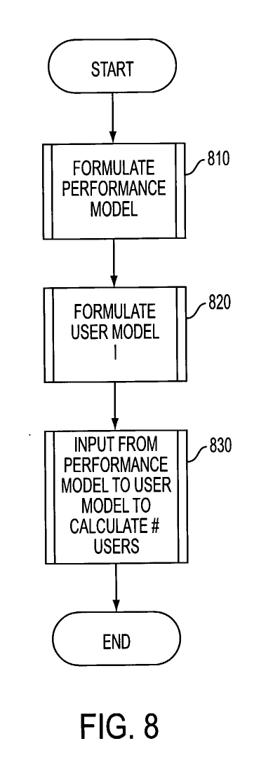

FIG. 8 illustrates the steps involved in the process of determining the number of concurrent users that can be supported by a web site having a pre-selected hardware configuration. In step 810, a performance model 150 is constructed in the same manner as described above with reference to FIG. 3. In step 820, a user model 160 is constructed as set forth above. Finally, in step 830, data derived from the testing performed using the performance model 150 is used in conjunction with the data derived from use of the user model 160 to calculate the number of concurrent users that can be supported by the web site.

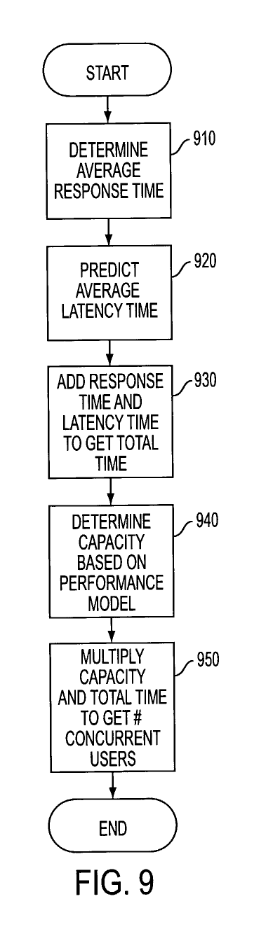

FIG. 9 illustrates another embodiment of the process for the construction of the user model in order to determine the number of concurrent users supported by a selected web site having a particular hardware configuration. In step 910, an average response time for executing a selected web application task is determined as described above. In step 920, an average latency time is determined as described above. In step 930, a total time figure is determined from the sum of the average response time and the average latency time. In step 940, the comparison means 170 calculates a capacity figure based on the results of the testing using the performance model 150. Finally, in step 950, the capacity figure resulting from the testing conducted using the performance model 150 and the total time figure from the user model 160 are multiplied to determine the number of concurrent users that the web site will support. It is understood that the explanation of process of FIG. 9 has been simplified to provide an overview of the process. One of ordinary skill in the art will recognize that the calculations performed may be complex and may require that sub-processes and sub-computations be performed in addition to the set forth above.

Once a web site has been launched, the web site proprietor may make use of the performance model 150 and the user model 160 to periodically refine the earlier calculations resulting therefrom as the proprietor obtains more accurate data relating to the actual number of concurrent users of the web site, and the response times for executing particular web application tasks. Such periodic refinement will serve to ensure that the hardware for the web site is upgraded as necessary to continue to support the number of concurrent users of the web site.

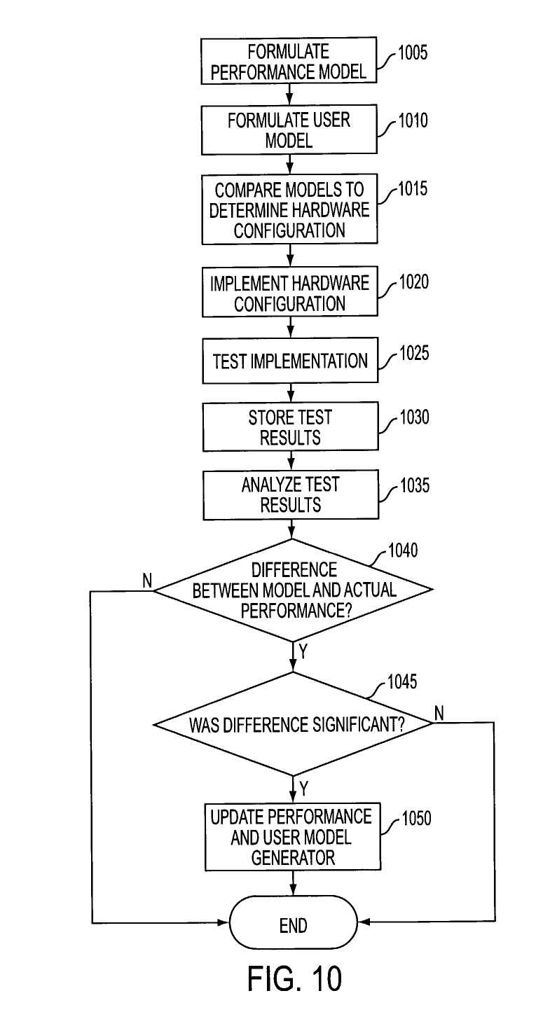

FIG. 10 illustrates the steps involved in the process for determining the required hardware configuration for a web site. A performance model 150 is constructed in step 1005. A user model 160 is constructed in step 1010. In step 1015, the results of the testing using the user model 160 are compared to the results of the testing using the performance model 150 to determine the hardware configuration best suited for the web site to support a projected number of concurrent users of the web site. The selected hardware configuration is implemented in step 1020. The hardware implementation is tested in step 1025, and the test results are stored in step 1030.

In step 1035, the test results are analyzed. According to an embodiment of the invention, analysis may be performed comparing the test results to the performance model and user model created at step 1005 and 1010, as well as with previous test results for a particular hardware configuration. Analysis may include, but is not limited, the capacity of the hardware configuration, latency periods for performing various tasks and applications, and the response time for users of the web site. In step 1040, a determination is made as to whether there is any difference between the test results and the results predicted by the user model and performance model. If not, the process ends. If there is a difference, a determination is made whether the difference is significant in step 1045. Small differences in response time, for example, may be considered small enough (e.g., 0.05 seconds) to ignore for purposes of the user model and performance model. According to an embodiment of the invention, a user may select the threshold of significance, ranging from all differences being significant to only certain differences (e.g., greater than 1 second, etc.) being significant. If the difference is not significant, the process ends. If the difference is significant, an update of the performance model and user model generators is performed at step 1050. Such an iteration may increase the accuracy of future projections of hardware requirements.

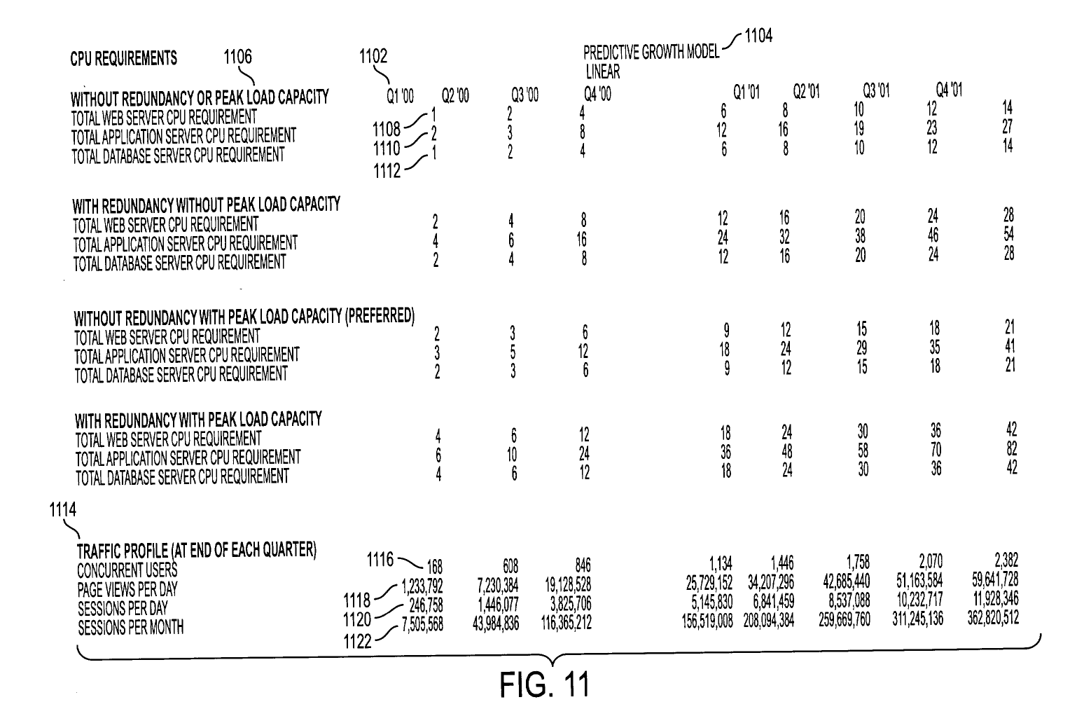

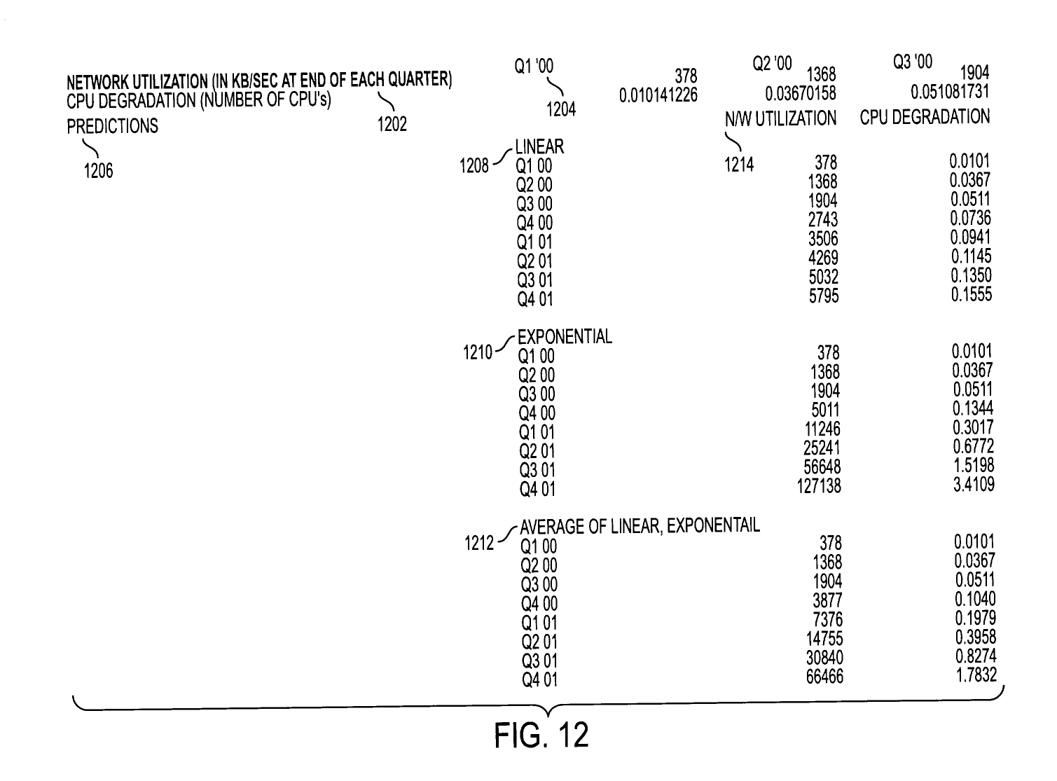

FIGS. 11 and 12 are representations on information presented for a user model, such as that illustrated in FIG. 9. According to an embodiment of the invention, information presented in FIGS. 11 and 12 may be representative of a user model. One aspect of the present invention may be the ability to present complex information in a managed fashion that is easier for a user to evaluate. Such as presentation may greatly simplify an otherwise complex process and calculation. FIG. 11 illustrates an estimate of central processing unit (“CPU”) requirements for specified period of time. In the example illustrated in FIG. 11, the time period 1102 is over a two year period, broken down into quarterly requirements. The title 1104 indicates that it is a predictive growth model on a linear basis. Other models, such as an exponential model or a combination of a linear and an exponential model may also be used.

Description 1106 may describe the portions of a system that are being predicted for the particular time period. By of the example illustrated in FIG. 11, description 1106 indicates that the “Total Web Server CPU Requirement,” the “Total Application Server CPU Requirement,” and the “Total Database Server CPU Requirement.” Further, description 1106 identifies that the system requirements are calculated without redundancy or peak load capacity. Other descriptions may include that the system requirements are calculated with redundancy but without peak load capacity, that the system requirements are calculated without redundancy but with peak load capacity, and that the system requirements are calculated with redundancy and with peak load capacity.

Quantity rows 1108, 1110, and 1112 provide the quantity of CPU's projected for the particular time frame. By way of the example illustrated in FIG. 11 at quantity row 1108, it may be estimated that one web server CPU is required in the first quarter of 2000 (Q1 '00), while eight web server CPUs are projected to required in the second quarter of 2001 (Q2 '01). Similarly, in quantity row 1110, two application server CPUs are expected to be used in the first quarter of 2000, while 19 application server CPUs are projected to be used in the third quarter of 2001 (Q3 '01). Further, in quantity row 1112, four database server CPUs are projected to be used in the third quarter of 2000 (3Q '00), while 14 database server CPUs are projected to be used in the fourth quarter of 2001 (Q4 '01). As can be seen in FIG. 11, other projections are also provided.

A traffic profile 1114 may be provided, where the traffic at the end of the quarter is given. In the example illustrated in FIG. 11, traffic profile 1114 provides information about the number of concurrent users, the number of page views per day, the number of sessions per day, and the number of sessions per month. For example, in the first quarter of 2001 (Q1 '00), the system is projected to accommodate 168 concurrent users, provide 1,233,792 page views per day, 246,758 sessions per day, and 7,505,568 sessions per month. By way of another illustrative example, in the second quarter of 2001 (Q2 '01), the system is projected to accommodate 1,446 concurrent users, provide 34,207,296 page views per day, 6,841,459 sessions per day, and 208,094,384 sessions per month. As illustrated, other projections are also presented, and based upon the system, may vary.

FIG. 12 illustrates a presentation of network utilization over a specific time period. In particular, title 1202 identifies the information as network utilization, which is presented in units of kilobytes per second (KB/sec), and degradation, which is presented in the number of CPUs necessary to accommodate the network degradation. In the illustrated example in FIG. 11, time period 1204 is broken out into quarters. However, other time periods may also be used. Subtitle 1206 identifies that the information is a prediction, while condition 1208 identifies the linear predictions, condition 1210 identifies the exponential predictions, and condition 1212 identifies the predictions that average the linear and exponential predictions. Further, measurements 1214 identify that network utilization and degradation are being predicted. In the example illustrated in FIG. 12, a linear prediction 1208 in the first quarter of 2001 (Q1 01) is that network utilization will be 3,506 KB/sec and degradation will be 0.0941 CPUs. An exponential prediction 1210 in the first quarter of 2001 (Q1 01) is that network utilization will be 11,246 KB/sec and degradation will be at 0.3017 CPUs. The average of the linear and the exponential prediction 1210 in the first quarter of 2001 (Q1 01) is that network utilization will be 7,376 KB/sec and degradation will be at 0.1979 CPUs. Other predictions are also illustrated.

As is demonstrated above, the system and process for projecting hardware requirements enables a web site proprietor to design a web site to support a particular load and to plan for natural growth of the load so that the web site does not experience technical difficulties.

It will be apparent to those skilled in the art that various modifications and variations can be made in the system and process of the present invention without departing from the spirit and scope of the invention. Thus, it is intended that the present invention cover the modifications and variations provided they come within the scope of the appended claims and their equivalents.

What is claimed is:

1. A process for projecting hardware requirements for a web site, wherein the web site makes use of a particular application platform, the process comprising the steps of:
building a performance model for the web site, wherein the step of building the performance model includes the sub-steps of:
a) selecting at least one feature for the web site;
b) selecting at least one web application task to execute from among a plurality of web application tasks which can be executed by a user of the web site via a browser; and
c) selecting a number of browsers to access the web site concurrently, each of the number of browsers corresponding to a user of the web site;
formulating a user model by predicting a plurality of parameters, the plurality of parameters including a number of concurrent users, an average latency time, and a desired response time;
calculating a desired capacity figure based on the predicted plurality of parameters; and
predicting a required hardware configuration.

2. The process according to claim 1, wherein building a performance model further comprises:
selecting one of a plurality of preliminary hardware configurations for the web site;
formulating a plurality of capacity result categories, with a capacity figure being allocated to each capacity result category, wherein for each one of the plurality of preliminary hardware configurations, the capacity figure is equal to a quotient of the number of browsers accessing the web site plus the number of internal subsystems that generate latency divided by the average response time; and
wherein predicting a required hardware configuration comprises comparing the calculated desired capacity figure with the formulated capacity figures for each of the capacity result categories of the performance model and using the one of the preliminary hardware configurations having the capacity figure matching the desired capacity figure for the required hardware configuration.

3. The process according to claim 2, wherein building a performance model further comprises:
testing the selected one of the preliminary hardware configurations by enabling the selected number of browsers to access the web site concurrently to execute the selected at least one web application task and observing a response time for each of the browsers accessing the web site to execute the selected at least one web application task;
determining an average response time for executing the selected at least one web application task; and
repeating the testing step for each one of the plurality of preliminary hardware configurations.

4. The process according to claim 1, wherein selecting at least one web application task comprises selecting at least one of a page request, a query, a transaction, and a weighted combination of the page request, the query, and the transaction.

5. The process according to claim 2, wherein the step of selecting one of the plurality of preliminary hardware configurations comprises selecting from a one CPU configuration and at least one of a 2(N) CPU system, where N a number greater than zero.

6. The process according to claim 1, wherein the number of concurrent users is predicted based on at least one of a projected natural growth number of concurrent users and a projected growth number of concurrent users due to advertising and publicity.

7. The process according to claim 1, wherein the average latency time is predicted by monitoring user preferences.

8. The process according to claim 1, wherein the average response time is determined based on a sum of each of the response times observed by each one of the number of browsers accessing the web site to execute the selected at least one web application task divided by the number of browsers.

9. The process according to claim 1, wherein the step of calculating the desired capacity figure comprises dividing the number of concurrent users by the sum of the average latency time and the average response time.

10. A process for predicting a maximum number of concurrent users that can be supported by a web site using a particular hardware configuration, the process comprising the steps of:
building a performance model for the web site and the particular hardware configuration, wherein building the performance model includes the sub-steps of:
selecting at least one web application task from among a plurality of application tasks which can be executed by a user of the web site via a browser; and
selecting a number of browsers to access the web site concurrently;
calculating a capacity figure;
formulating a user model by predicting an average latency time and a desired response time; and
calculating the maximum number of concurrent users that can be supported by the web site by selecting the calculated capacity figure from an appropriate result category and multiplying the selected calculated capacity figure by the sum of the average latency time and the desired response time.

11. The process according to claim 10, wherein building a performance model further comprises:
creating a result category for each one of the plurality of web application tasks; and
conducting a capacity test for each result category using the selected web application task; and
wherein calculating a capacity further comprises calculating a capacity figure for each result category, wherein the step of calculating the capacity figure includes the sub-step of determining an average response time and dividing the number of browsers accessing the web site by the determined average response time.

12. The process according to claim 10, wherein the at least one web application task is selected from a plurality of web application tasks including a page request, a query, a transaction, and a weighted combination of the page request, the query, and the transaction.

13. The process according to claim 10, wherein the average latency time is predicted by monitoring user preferences.

14. The process according to claim 10, wherein the average response time is determined based on a sum of each of the response times observed by each of the number of browsers accessing the web site divided by the number of browsers.

15. A process for building a performance model for a web site, the process comprising the steps of:
selecting a plurality of features for the performance model including a particular programming language platform;
selecting at least one web application task from among a plurality of web application tasks which can be executed by a user of the web site;
selecting at least one CPU configuration from among a plurality of CPU configurations;
selecting a number of browsers to access the web site concurrently;
creating a plurality of result categories by forming a graph having a first axis corresponding to the selected web application task and a second axis corresponding to the selected CPU configuration;
performing a capacity test for each one of the plurality of result categories using the selected web application task; and
calculating a capacity figure for each one of the plurality of result categories, wherein the step of calculating the capacity figure includes the sub-steps of determining an average response time, and dividing the selected number of browsers accessing the web site by the determined average response time.

16. The process according to claim 15, wherein the particular platform comprises one of a Netscape application, a Broadvision application, a C++ platform and a Java platform.

17. The process according to claim 15, wherein the web application task is selected from a plurality of web application tasks including a page request, a query, a transaction, and a weighted combination of the page request, the query, and the transaction.

18. The process according to claim 15, wherein the step of selecting one of a plurality of preliminary hardware configurations comprises selecting from a one CPU configuration and at least one of a 2(N) CPU system, where N is a number greater than zero.

19. A system for predicting hardware requirements for a web site, wherein the web site uses a particular programming language platform, the system comprising:
a performance model for the web site, wherein the performance model includes a plurality of capacity result categories, a capacity figure being provided for each one of the plurality of capacity result categories, each of the capacity figures being determined as a quotient of a number of browsers accessing the web site concurrently divided by an average response time for the number of browsers to execute a selected web application task;
a user model including means for predicting a plurality of parameters including a number of concurrent users, an average latency time, and a desired response time, and means for calculating a desired capacity figure based on the predicted plurality of parameters; and
comparison means for predicting a required hardware configuration by comparing the calculated desired capacity figure with the determined capacity figures of the performance model.

20. The system according to claim 19, wherein the number of concurrent users is predicted based upon at least one of a projected natural growth figure of concurrent users and a projected growth figure of concurrent users resulting from advertising and publicity.

21. The system according to claim 19, wherein the prediction means compares a capacity figure required to support the predicted number of concurrent users with each one of the capacity figures determined by use of the performance model.

22. A system for predicting a number of concurrent users that can be supported by a web site using a particular hardware configuration, the system comprising:
a performance model for the web site and the particular hardware configuration, wherein the web site includes a plurality of web application tasks which can be executed by a user of the web site, a result category for each one of the plurality of web application tasks and a capacity figure for each result category, wherein each one of the capacity figures is determined by a number of browsers accessing the web site concurrently divided by an average response time; and
a user model including a plurality of user parameters including an average latency time and a desired response time, the user model including means for calculating the maximum number of concurrent users than can be supported by the web site by selecting the capacity figure from an appropriate result category and multiplying the selected capacity figure by the sum of the average latency time and the desired response time.

23. A medium storing code for causing a processor to project hardware requirements for a web site, wherein the web site makes use of a particular application platform, the medium comprising:
code for building a performance model for the web site, wherein the code for building the performance model includes:
a) code for selecting at least one feature for the web site;
b) code for selecting at least one web application task to execute from among a plurality of web application tasks which can be executed by a user of the web site via a browser; and
c) code for selecting a number of browsers to access the web site concurrently, each of the number of browsers corresponding to a user of the web site;
code for formulating a user model by predicting a plurality of parameters, the plurality of parameters including a number of concurrent users, an average latency time, and a desired response time;
code for calculating a desired capacity figure based on the predicted plurality of parameters; and
code for predicting a required hardware configuration.

24. The medium according to claim 23, wherein the code for building a performance model further comprises:
code for selecting one of a plurality of preliminary hardware configurations for the web site;
code for formulating a plurality of capacity result categories, with a capacity figure being allocated to each capacity result category, wherein for each one of the plurality of preliminary hardware configurations, the capacity figure is a function of the number of browsers accessing the web site, the performance of internal subsystems that generate latency, and the average response time; and
wherein the code for predicting a required hardware configuration comprises code for comparing the calculated desired capacity figure with the formulated capacity figures for each of the capacity result categories of the performance model and using the one of the preliminary hardware configurations having the capacity figure matching the desired capacity figure for the required hardware configuration.

25. The medium according to claim 24, wherein the code for building a performance model further comprises:
code for testing the selected one of the preliminary hardware configurations by enabling the selected number of browsers to access the web site concurrently to execute the selected at least one web application task and observing a response time for each of the browsers accessing the web site to execute the selected at least one web application task;
code for determining an average response time for executing the selected at least one web application task; and
code for repeating the testing step for each one of the plurality of preliminary hardware configurations.

26. The medium according to claim 23, wherein the code for selecting at least one web application task comprises code for selecting at least one of a page request, a query, a transaction, and a weighted combination of the page request, the query, and the transaction.

27. The medium according to claim 23, wherein the code for selecting one of the plurality of preliminary hardware configurations comprises code for selecting from a one CPU configuration and at least one of a 2(N) CPU system, where N is a number greater than zero.

28. The medium according to claim 23, wherein the number of concurrent users is predicted based on at least one of a projected natural growth number of concurrent users and a projected growth number of concurrent users due to advertising and publicity.

29. The medium according to claim 23, wherein the average latency time is predicted by monitoring user preferences.

30. The medium according to claim 23, wherein the average response time is determined based on a sum of each of the response times observed by each one of the number of browsers accessing the web site to execute the selected at least one web application task divided by the number of browsers.

31. The medium according to claim 23, wherein the code for calculating the desired capacity figure comprises dividing the number of concurrent users by the sum of the average latency time and the average response time.

32. A medium storing code for causing a processor to build a performance model for a web site, the medium comprising:
code for selecting a plurality of features for the performance model including a particular programming language platform;
code for selecting at least one web application task from among a plurality of web application tasks which can be executed by a user of the web site;
code for selecting at least one CPU configuration from among a plurality of CPU configurations;
code for selecting a number of browsers to access the web site concurrently;
code for creating a plurality of result categories by forming a graph having a first axis corresponding to the selected web application task and a second axis corresponding to the selected CPU configuration;
code for performing a capacity test for each one of the plurality of result categories using the selected web application task; and
code for calculating a capacity figure for each one of the plurality of result categories, wherein the step of calculating the capacity figure includes the sub-steps of determining an average response time, and dividing the selected number of browsers accessing the web site by the determined average response time.

33. The medium according to claim 32, wherein the particular platform comprises one of a Netscape application, a Broadvision application, a C++ application and a Java application.

34. The medium according to claim 32, wherein the web application task is selected from a plurality of web application tasks including a page request, a query, a transaction, and a weighted combination of the page request, the query, and the transaction.

35. The medium according to claim 32, wherein the code for selecting one of a plurality of preliminary hardware configurations comprises code for selecting from a one CPU configuration and at least one of a 2(N) CPU system, where N is a number greater than zero.
